(19) United States
(12) Patent Application Publication
(10) Pub. No.: US 2021/0309157 A1
(43) Pub. Date: Oct. 7, 2021

(54) Supplemental Vehicle Utility Console

(71) Applicant: John J. Gentile, Hazlet, NJ (US)

(72) Inventor: John J. Gentile, Hazlet, NJ (US)

(21) Appl. No.: 16/838,460

(22) Filed: Apr. 2, 2020

(51) Int. Cl. B60R 7/06

(52) U.S. Cl. CPC B60R 7/06

(57) ABSTRACT

A supplemental vehicle utility console for any vehicle having an integral vehicle console with an inset storage pocket is provided having a main storage compartment with an upper section, a lower section, and first and second sidewalls. The upper section is pivotably connected to a cantilevered shelf member having a flat top surface and a bottom surface with at least one integral console insert member having an open pocket. One or more of the console insert members extend down from the bottom surface of the shelf member and are configured to conform to the shape of the existing vehicle console storage pockets, so as to fit snugly within the storage pockets in the vehicle console. The utility console also has a variety of storage compartments attached to the main storage compartment for the placement of various items which are thereby easily accessible to the vehicle driver.

### BACKGROUND OF THE INVENTION

It is imperative that vehicle drivers always maintain strict attention to driving and, especially, to constantly keeping their eyes on the road. This is equally, if not more important, for drivers of big rigs, who routinely haul thousands of pounds of products in forty-foot containers. If the attention of a such driver is diverted, even for a fraction of a second, the accident which could result could be disastrous.

As a result, if today's truck drivers wish to engage in a non-driving directed activity while operating their vehicles, e.g. taking a bottle of water from a nearby refrigerator in the cab of the vehicle, making written notes, using a calculator to determine mileage, fuel consumption, etc., the driver must find a secure area to park, bring the rig to a complete stop, conduct the activity, and then again start out. This takes valuable time, which truckers prefer not to lose. As a result, many truckers will continue driving while attempting to perform many of these non-driving activities. The safety danger this presents as the driver's attention is diverted is obvious.

Currently, the cabs of most truck-trailers have vehicle consoles with very limited pockets, spaces, or areas in which the driver can place accessible items needed while driving. Although current vehicle consoles have cup holders and a pocket for maps or vehicle papers, these consoles do not sufficiently address a driver's needs. This results in causing the driver to reach for needed items while driving, thus risking an accident.

### SUMMARY OF THE INVENTION

It is thus the object of the present invention to provide a supplemental vehicle utility console which can be easily installed into existing vehicle consoles, and which provides a number of storage compartments and spaces for items which are readily and safely accessible to the driver while he or she is operating a vehicle.

These and other objects are accomplished by the present invention, a supplemental utility console for any vehicle having an integral vehicle console with a storage pocket inset within that vehicle console. The supplemental utility console has a main storage compartment with an upper section, a lower section, and first and second sidewalls. The upper section is pivotably connected to a cantilevered shelf member having a flat top surface and a bottom surface with at least one integral console insert member having an open pocket. One or more of the console insert members extend down from the bottom surface of the shelf member and are configured to conform to the shape of the existing vehicle console storage pockets, so as to fit snugly within the storage pockets in the vehicle console. The utility console also has a variety of storage compartments attached to the main storage compartment for the placement of various items which are thereby easily accessible to the vehicle driver.

The novel features which are considered as characteristic of the invention are set forth in particular in the appended claims. The invention itself, however, both as to its design, construction, and use, together with additional features and advantages thereof, are best understood upon review of the following detailed description with reference to the accompanying drawings.

### BRIEF DESCRIPTION OF THE DRAWINGS

FIG. 1 is an exploded view of the supplemental vehicle utility console of the present invention aligned in positioned over storage pocket insets of an existing vehicle console.

FIG. 2 is a detailed exploded view of the supplemental vehicle utility console of the present invention aligned in positioned over storage pocket insets of an existing vehicle console.

FIG. 3 is a view of the supplemental vehicle utility console of the present invention positioned within storage pocket insets of an existing vehicle console.

FIG. 4 is a detailed view of the supplemental vehicle utility console of the present invention positioned within storage pocket insets of an existing vehicle console.

FIG. 5 is a top view of the supplemental vehicle utility console of the present invention.

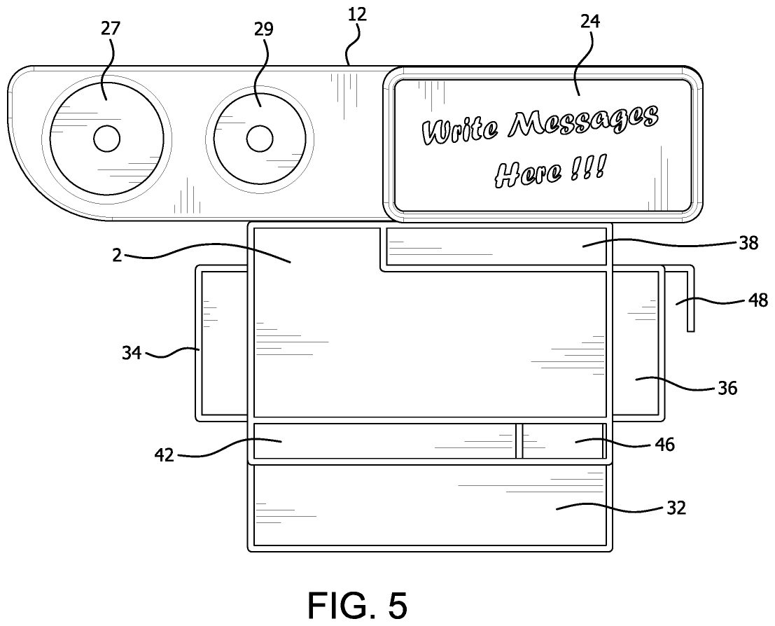

FIG. 6 is an exploded view of the various items which can be placed in the supplemental vehicle utility console of the present invention.

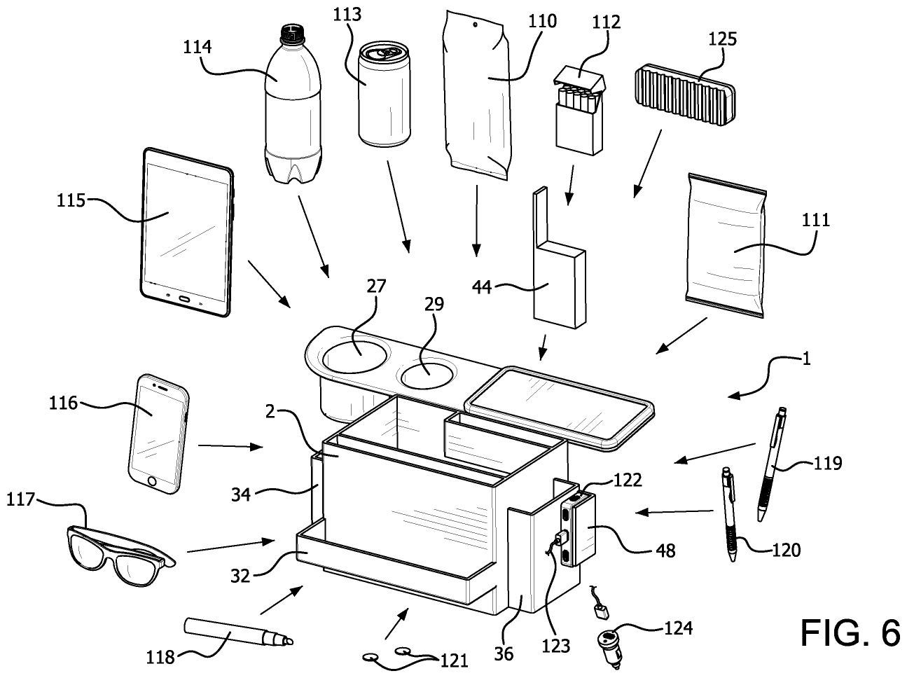

FIG. 7 shows the items in FIG. 6 located and stored within the supplemental vehicle utility console of the present invention.

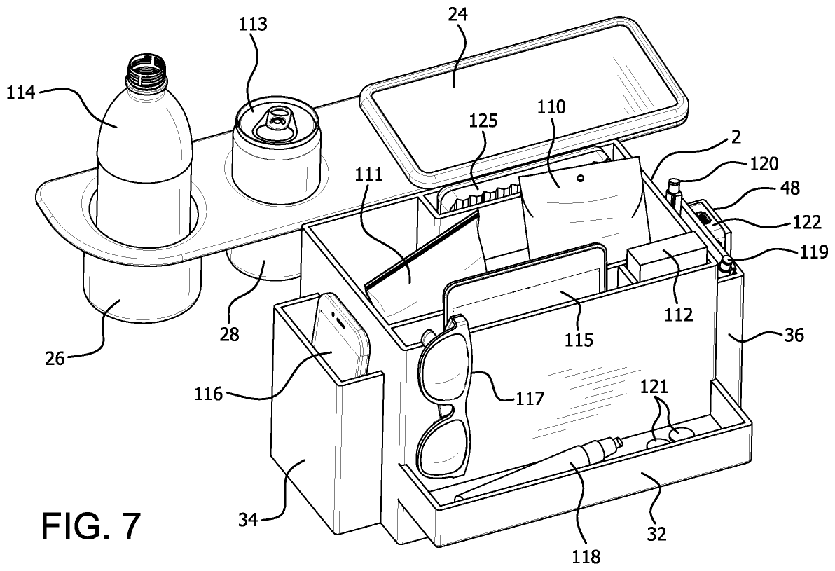

FIG. 8 is an alternate view of the supplemental vehicle utility console of the present invention shown in FIG. 7.

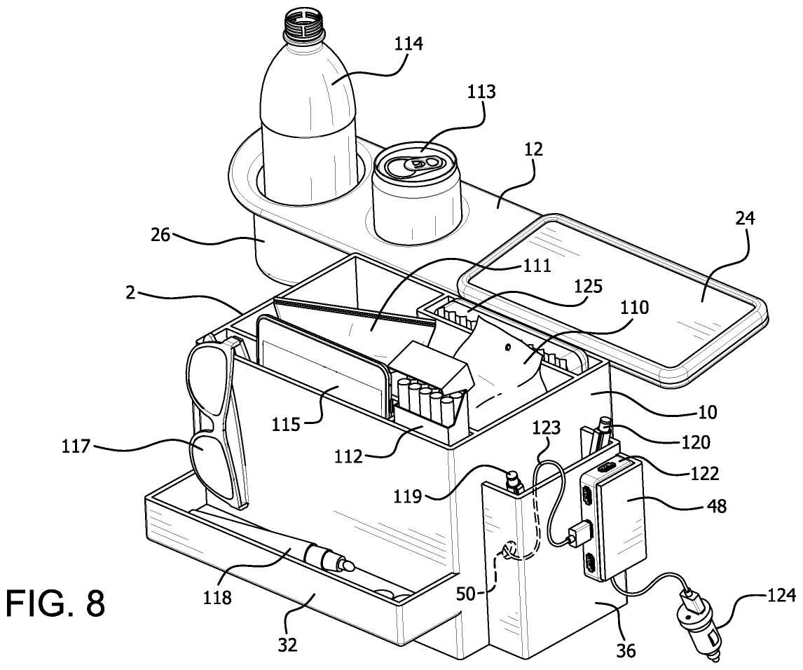

FIG. 9 is an elevation review of the supplemental vehicle utility console of the present invention illustrating the pivotable nature of its cantilevered shelf.

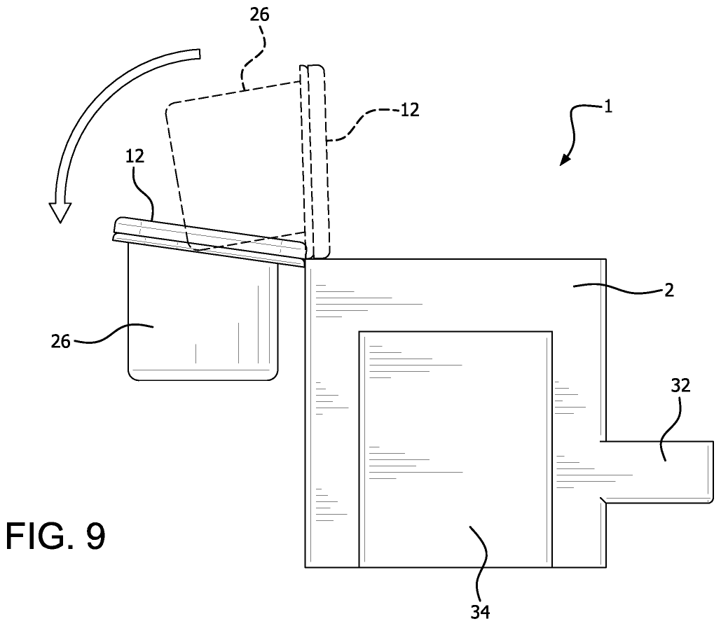

### DETAILED DESCRIPTION OF THE INVENTION

Supplemental vehicle utility console 1 comprises main compartment 2 having internal space 3, upper section 4, lower section 6, and side walls 8 and 10. Cantilevered shelf member 12 is pivotably connected, by permanent hinge joint 14, to upper section 4.

Shelf member 12 has flat top surface 16 having circular openings 20 and 22 and writing pad 24, which can consist of a paper pad or writing screen for erasable markers. Console insert members 26 and 28 have open pockets 27 and 29 from which spaces extend. They are integral with and extend down from bottom surface 18 of shelf member 12. Console inserts 26 and 28 are shaped to conform with the shape of vehicle internal storage pockets 102 and 104 inset within existing vehicle console 100, an OEM component integral on most vehicles. Console inserts 26 and 28 are designed to fit snugly within storage pockets 102 and 104.

The present invention is not to be considered restricted to the shape of the console insert members disclosed herein. It is contemplated that console insert members 26 and 28 will be custom manufactured to fit the various storage pockets which already exist in the vast majority of truck and other vehicle consoles.

Second storage compartment 32 is attached to lower section 6 of main compartment 2, third storage compartment 34 is attached to side wall 8 of the main storage compartment, fourth storage compartment 36 is attached to sidewall 10 of main compartment 2, and fifth storage compartment 38 is attached at upper section 4 of the main storage compartment. Intermediate wall member 40 within main compartment 2 establishes sixth compartment 42 within the main compartment. Wall member component 44 within sixth compartment 42 establishes a seventh compartment 46 within the sixth compartment.

Opening 50 is provided through side wall 10 to allow electrical wiring and/or internet cable 123 to extend from a connection in the vehicle cab, into compartment 36 and then into e.g. electronic device or battery charger 122 which is positioned within eighth compartment 48.

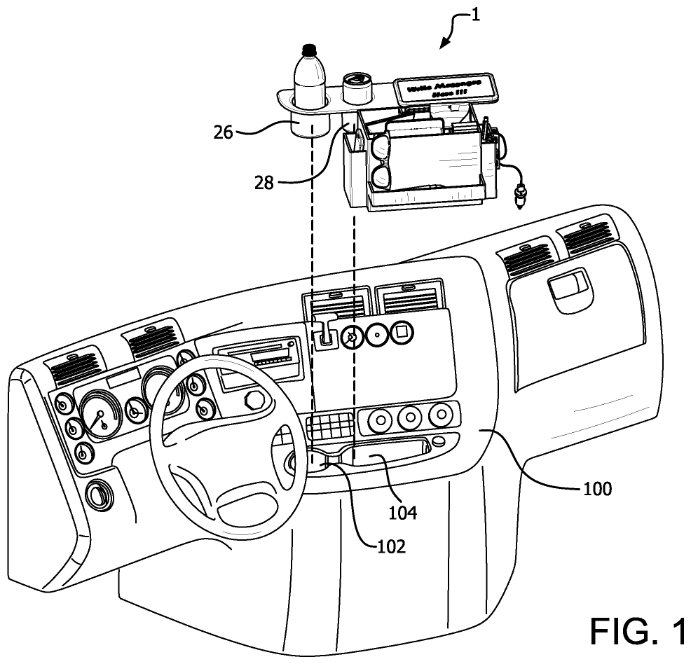

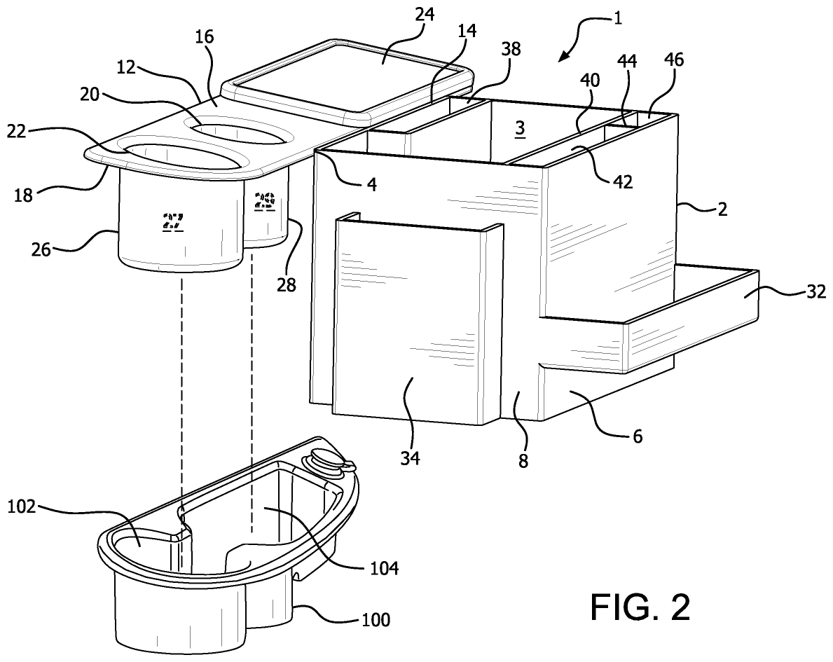

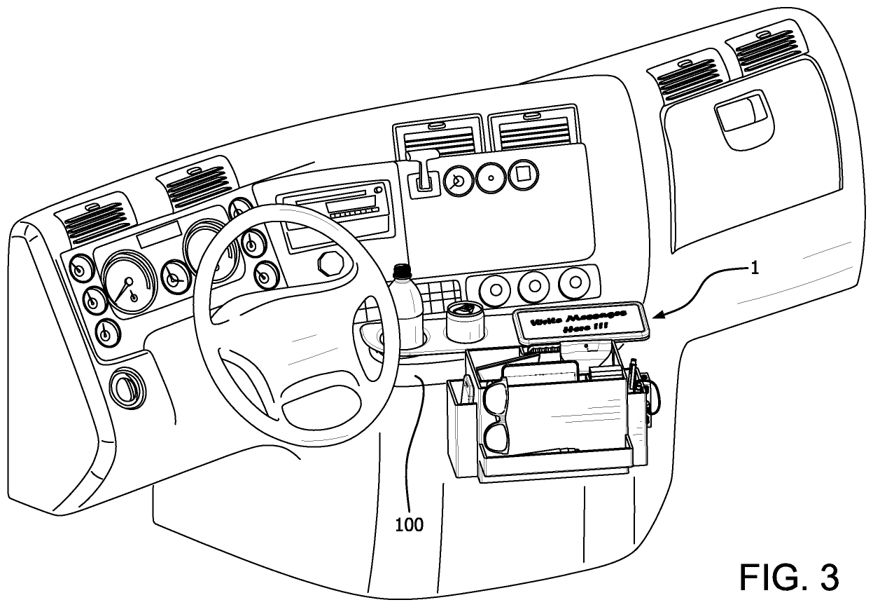

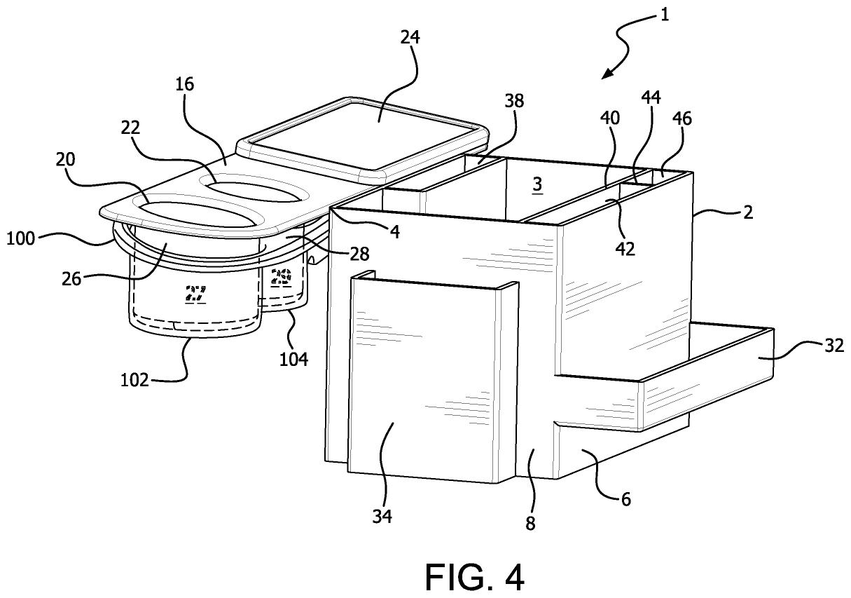

In use, shelf member 12 of supplemental utility console 1 is first angled down, so that console insert members 26 and 28 are aligned over storage pockets 102 and 104 of vehicle console 102. See FIGS. 1 and 2. Console insert members 26 and 28 are then inserted into storage pockets 102 and 104, such that supplemental utility console 1 is rigidly affixed within the vehicle console, as seen in FIGS. 3 and 4. The vehicle operator is then free to place items of his or her choice within the various spaces and compartments of main compartment 2, e.g. food snacks 110 and 111, cigarette pack 112, liquid carrying containers 113 and 114, computer tablet 115, smart phone 116, eyeglasses 117, writing implements 118, 119, 120, coins 121, battery charger 122 and electrical cable and attachments 123 and 124 and brush 125. As a result, all these items, as well as writing pad 24, become readily, and safely, accessible to the vehicle driver, while he or she is operating a vehicle.

While the present invention is more particularly directed to vehicle consoles in truck cabs, it can be readily adapted for use in passenger vehicles as well.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A supplemental utility console for a vehicle having an integral vehicle console, the vehicle console having a storage pocket inset, said supplemental utility console comprising:
a main storage compartment having an upper section, a lower section, and first and second side walls, the upper section being pivotably connected to a cantilevered shelf member having a flat top surface and a bottom surface, and at least one integral console insert member having an open pocket, said console insert member extending down from the bottom surface of the shelf member, the console insert member being configured to conform to the shape of the vehicle console storage pocket and to fit snugly within said storage pocket;
a second storage compartment attached to the lower section of the main storage compartment; and
at least one additional storage compartment attached to the main storage compartment.

2. The supplemental utility console as in claim 1 wherein the at least one console insert member comprises top openings from which spaces extend to accept liquid carrying containers.

3. The supplemental utility console as in claim 1 further comprising a writing pad positioned on the top surface of the shelf member.

4. The supplemental utility console as in claim 1 wherein the at least one additional storage compartment comprises multiple auxiliary storage compartments extending from the main storage compartment.

5. The supplemental utility console as in claim 1 further comprising an opening through the main storage compartment into which electrical wiring and internet cable can be inserted.

6. The supplemental utility console as in claim 1 wherein the shelf member is pivotably connected to the upper section of the main storage compartment by a permanent hinge.

7. A supplemental utility console for a vehicle having an integral vehicle console, the vehicle console having a storage pocket inset, said supplemental utility console comprising:
a main storage compartment having an upper section, a lower section, side walls, the upper section being pivotably connected to a cantilevered shelf member having a flat top surface and a bottom surface, at least one integral console insert member having an open pocket, said console insert member extending down from the bottom surface of the shelf member, the console insert member being configured to conform to the shape of the console storage pocket and to fit snugly within said storage pocket, said storage pocket having top openings from which spaces extend to accept liquid carrying containers;
a writing pad positioned on the top surface of the shelf member;
a second storage compartment attached to the lower section of the main storage compartment;
a third storage compartment attached to the first side wall of the main storage compartment;
a forth storage compartment attached to the second side wall of the main storage compartment;
at least one separate compartment located within the main storage compartment; and
an opening though the main storage compartment into which electrical wiring and internet cable can be inserted.

8. The supplemental utility console as in claim 7 wherein the shelf member is pivotably connected to the upper section of the main storage compartment by a permanent hinge.
